(19) United States
(12) Patent Application Publication
(10) Pub. No.: US 2018/0295137 A1
(43) Pub. Date: Oct. 11, 2018

(54) TECHNIQUES FOR DYNAMIC AUTHENTICATION IN CONNECTION WITHIN APPLICATIONS AND SESSIONS

(71) Applicant: Iconix, Inc., San Jose, CA (US)

(72) Inventors: Robert Philip Zager, Saratoga, CA (US); Scott A. Sachtjen, San Jose, CA (US); Jose Jesus Picazo, JR., Livermore, CA (US)

(21) Appl. No.: 15/946,637

(22) Filed: Apr. 5, 2018

Related U.S. Application Data
(60) Provisional application No. 62/482,375, filed on Apr. 6, 2017.

(51) Int. Cl. H04L 29/06

(52) U.S. Cl. CPC H04L 63/102; H04L 2463/082; H04L 63/0853; H04L 63/0861

(57) ABSTRACT

An Interceptor identifies requests to access a protected function or resource and dynamically invokes one or more additional authentication tests. The Interceptor for example can be configured as a plug-in for an email client, or can be integrated with native application code (or web content). The authentication tests in one implementation test inherence features, such as biometrics of a user seeking resource access. The authentication tests can be static or dynamically configured by one or more rules, and the protected functions can be designated by the Interceptor or a database or file reference. Dynamic authentication is invoked above and beyond any conventional authentication steps required of a login device (for example, user ID and password or the continued presence of a connected token). Properly structured, the additional authentication steps thwart hijacking and other hacking techniques that can seek to leverage legitimate initial client login.

This application claims the benefit of U.S. Provisional Patent Application No. 62/482,375, filed on Apr. 6, 2017 on behalf of first-named inventor Robert Philip Zager for “A System For Improved Cybersecurity In A Compromised Credential Environment;” this provisional application is hereby incorporated by reference.

This disclosure relates to techniques for authentication and, more particularly, to authenticating the presence of an authorized user.

### BACKGROUND

A conventional goal of cyber security is restricting the use of data processing resources to an intended user. Control of access presents problems related to the identification of the user. Multi-factor authentication (MFA) refers to a type of access control in which the user must successfully present several separate pieces of evidence to an authentication process in order to gain access to a system. In other words, the user's claimed identity (for example “user A”) is confirmed by presenting verifying information for each factor of in the authentication process. Each verification step or factor generally falls into three categories:
a. “What You Know” (i.e., knowledge-based) Techniques: Common examples include techniques where a user must correctly provide a pre-established password, a PIN (Personal Identification Number) or answer to a secret questions such as “Where were you born?” or “What was the last transaction on this account?”
b. “What You Have” (possession-based) Techniques: Common examples include techniques where a user must present a specific token, such as: a bank card; a USB stick having secret information encoded in an integrated circuit (IC); a specific cellphone; or a specific key used to operate a keyed switch. The presumption with these techniques is that only the authorized user is in possession of the correct token. Tokens are further generally of two types, connected and disconnected. A connected token is one communicatively-connected (e.g., by physical insertion into a connector or by wireless electromagnetic means such as WIFI, Near Field Communication, or by Bluetooth) to a system being used. A disconnected token is one not communicatively-connected to the system in question, but rather, one which typically displays information which the user must then enter into the computer; common examples of disconnected tokens include the RSA SecurID token and one-time password (OTP) systems which utilize a cell phone as the token (e.g., such as FreeOTP).
c. “What You Are” (inherence) Techniques: Common examples include techniques which verify biological markers such as fingerprints, iris, voice, typing (or gesture) characteristics and facial features.

MFA techniques require that multiple verification tests must be satisfied by a user before that user will be authenticated. For example, two-factor authentication (2FA) is a type of multifactor authentication in which two tests must be satisfied in order to authenticate a user. In one typical implementation, a conventional point of sale payment terminal may require both the swipe of a bank card (something the user processes) and presentation of the correct PIN (something the user knows) in order to authenticate a specific card holder as authorized to conduct a transaction using an account referenced by the bank card. MFA techniques are widely deployed and are in general use worldwide. NIST Special Publication 800-63-2 discusses 2FA and provides guidance on business processes to implement 2FA. In another example implementation, access to some U.S. government systems (e.g., remotely via the Internet, or to log into a specific computer) requires the continued presence (i.e., connected presence) of a special government smartcard that has an embedded security IC and the use of a PIN. This methodology provides a level of assurance that the authorized user is physically present at the system, at least when a session is initiated, because the person initiating the session is in possession of both the smart card and the PIN.

While useful for the intended purpose of authenticating a user seeking to login or gain initial access to a computer system or system, the techniques discussed above do not necessarily guarantee that subsequent actions are taken by the initiating user, and there are many examples of security attacks that can nevertheless still occur.

One class of attack is exemplified by cyberattacks against the US Department of Defense (DoD) and Window smart cards used in the defense sector. Such an attack is described by Alienvault Labs in a Jan. 12, 2012 posting; in this attack, malware in the form of a Sykipot variant was used to hijack DoD and Windows smart cards. This malware operates by installing a keylogger which steals and stores the PIN. Once the smartcard is inserted in a reader, the malware acts as an authenticated user which then can subsequently log onto remote resources supposedly protected by the smartcard. As long as the smartcard remains inserted in the card reader (a requirement for the authorized user to use the system due to the fact that removing the card ends the session authorized with the card), the malware can surreptitiously use the smartcard to authenticate and access resources. As Alienvault Labs noted, “[a]n interesting by-product of this malware's necessity of having the card physically present is that attackers can only leverage it for secure authentication to target systems during times that the user them is physically present at the workstation, making unauthorized activity that much more difficult to discern from legitimate usage.” The malware in this case issues system commands in the presence of the smartcard without the active participation of the authorized user. The authorized user may be unaware of the activity because the user's attention is directed elsewhere (for example, the user could move away from the computer, leaving the card in the reader or the user might be near the machine but engaged in an activity that does not involved looking at the monitor) or because the processes which were not authorized by the authorized user were being run without any indications on the authorized user's monitor.

Another example was presented in connection with a December 2015 power grid disruption in Ukraine. As reported by WIRED in a Mar. 3, 2016 article, “Inside the Cunning, Unprecedented Hack of Ukraine's Power Grid,” at some time prior to the disruption of the power grid, a cyberattacker used a spearphishing email to trick an authorized user into installing Remote Access Tool (RAT) malware onto the authorized user's system. At a time of the attacker's choosing, the attacker used the RAT malware to access the authorized user's system. As the authorized user watched, the attacker navigated on the authorized user's monitor and commenced to take substations off-line. The attacker then logged the authorized user off of the system. As the attack continued, the authorized user attempted login to the power grid management application—without success—because the attacker had changed the password. In this case, the physical presence of the authorized user at the appropriate workstation was irrelevant to the unauthorized user's ability to operate the authorized computer.

Other examples involve techniques that access a user's login device to access applications previously accessed using the device. The reusing of previously accessed applications in connection with a compromised device is described by Alexander Korznikov in a Mar. 17, 2017 article, “Passwordless RDP Session Hijacking Feature All Windows versions.” Korrznikov observes that physical access to the login device is not required; a RAT will work, too.

A related technique is represented by multi-stage spearphishing attacks. The CERT Insider Threat Team describes this class of problem in its report to DHS entitled, “Unintentional Insider Threats: A Review of Phishing and Malware Incidents by Economic Sector.” In a multi-stage spearphishing attack, an attacker first uses a spearphishing attack to steal the credentials of an email account. Such an attack was seen in the widely reported case of John Podesta, Hillary Clinton's presidential campaign manager. Having taken control of the first email account through the use of stolen credentials, the attacker then uses this first compromised email account (of a first user) to send a second stage spearphishing attack to a new victim. The second victim is put at a substantial disadvantage in detecting the second phase of the attack because the attack email is actually originating from a trusted account (i.e., the email account of the first user, who is known to and trusted by the new victim). In 2015, President Obama's calendar was accessed by Russian hackers using a multi-stage spearphishing attack. In the first stage of the attack, a State Department email account was compromised. In the second stage of the attack, the attacker used the legitimate (but compromised) State Department email account to send a malicious email to the White House. The unauthorized user used the State Department system without the presence of the authorized user. Although the second stage spearphishing email was not authored by the State Department employee associated with the sending State Department email account, the second stage spearphishing email contained no technical indications that it was not authorized by the actual authorized user. The email system at the White House processed this attack email as originating from the State Department because it did originate from the State Department. The White House human recipient of the email also treated the email as a real State Department email authored by an authorized State Department employee, despite the fact that the second stage email, although coming from the State Department email system and was not authored by the State Department employee associated with the email account. Believing the email was a legitimate State Department email, the White House employee opened the second stage spearphishing email, resulting in the Russian hackers gaining access to the President's calendar. In other words, in the first stage attack on the State Department, the attacker masqueraded as someone trusted by State Department employee and this masquerade had technical attributes which could be observed by a careful user to avoid deception. However, in the second stage of the attack, there were no technical attributes of deception because the email actually originated from the compromised account—the attacker who controls the real email account can send email without the presence of the authorized user and such an email contains no technical indications that the authorized user was not present to author the email.

Still another example of the use of a system without the presence of the authorized user is represented by the compromise of over five hundred million Yahoo! user accounts. According to the FBI, in an interview reported by Ars Technica on Mar. 15, 2017 entitled, “How did Yahoo get breached? Employee got spear phished, FBI suggests,” attackers used a combined attack methodology. After using a RAT to infiltrate Yahoo!, the attackers discovered a Yahoo! tool which allowed the attackers to use abuse cookie functionality and access Yahoo! users' accounts without use of the associated username and password or the user's computer; in other words, buy using the cookie generated using the Yahoo! tools, unauthorized users were able to login to the users' accounts using any computer, not just a computer which was logged-on by the authorized user. The Yahoo! compromise is an example of accessing accounts without using a RAT to compromise the authorized user's login device. We use the term “Unauthorized Access Tools” (UAT) to describe unauthorized access which does not use a RAT installed on the authorized user's login device. Examples of UAT other than the Yahoo! example described by Ars Technica include using stolen credentials, guessing credentials, session hijacking using cookie hijacking, source-routed IP packets or man-in-the-middle attacks, and VPN session hijacking

As each of these examples underscore, a client login device is not necessarily under the exclusive control of the authorized user at any given moment. Even in cases where an authorized user is required to maintain connection of a physical token inserted in the client login device, attackers can still create daughter sessions posing as the authorized user or access and use access granted in connection with prior sessions. Alternatively, attacker can access resources without using the client login device by methods such as using the authorized user's user name and password passwords, session hijacking and VPN hijacking.

What are needed are techniques for improving network and systems security, ideally using techniques that verify, even subsequent to a legitimate system or session logon, that specific actions are individually initiated or approve of by the authorized user. The present invention addresses these needs and provides further, related advantages.

### BRIEF DESCRIPTION OF THE DRAWINGS

FIG. 1 is a diagram illustrating an exemplary environment in which one embodiment of the techniques disclosed herein may be implemented.

FIG. 2 is a block diagram of a system that provides for multi-factor authentication.

FIG. 3 is a block diagram illustrating operations performed the authentication system that uses techniques presented by this disclosure.

FIG. 4A is a data flow diagram illustrating user authentication in a system exposed to a remote access tool (RAT) attack situation, and how techniques provided by this disclosure can be used to thwart such an attack.

FIG. 4B is a data flow diagram illustrating user authentication in a system exposed to an unauthorized access tool (UAT) attack situation, and how techniques provided by this disclosure can be used to thwart such an attack.

FIG. 5 is a logic flow diagram illustrating authentication techniques performed in one embodiment.

FIG. 6A is a diagram showing exemplary designated functions rules.

FIG. 6B is a diagram showing exemplary client verification rules.

FIG. 6C is a diagram showing exemplary rules configuration.

FIG. 6D is a diagram showing user data functions.

The subject matter defined by the enumerated claims may be better understood by referring to the following detailed description, which should be read in conjunction with the accompanying drawings. This description of one or more particular embodiments, set out below to enable one to build and use various implementations of the technology set forth by the claims, is not intended to limit the enumerated claims, but to exemplify their application. Without limiting the foregoing, this disclosure provides several different examples of techniques for authentication methodologies that are invoked within an application when a user takes an action, or within a session, where those authentication methodologies use presence detection. The various techniques can be embodied as software for performing these techniques (downloaded or otherwise), in the form of a computer or in the form of another electronic device or system (e.g., a smart phone app). While specific examples are presented, the principles described herein may also be applied to other methods, devices and systems as well.

### DETAILED DESCRIPTION

### A. Introduction.

Techniques presented by this disclosure require invoke one or more additional authentication functions in connection with individual user actions, that is, above and beyond any authentication factors which may be required for initial system login or session initiation. In one embodiment, these added authentication functions can be of a type that require user presence at the client login device (e.g., using any of the traditional factors of knowledge, possession and inherence) at points related to system processing or session processing (e.g., invoked dynamically when a user seeks to take an action within an application, such as accessing memory, or within a session, such as transferring bank funds); these examples are non-limiting. Thus, for example, although a user might have instantiated a data processing session, at a predetermined step or steps in a data processing activity, the user can be dynamically required to perform an authentication task (e.g., a 2FA task) to demonstrate that the user is in geographic proximity to a specific computer system and/or a client login device at that moment. If the user is able to successfully perform the requested authentication task within the time allotted, then the requested data processing activity will be allowed to proceed. If the user is unable to perform the requested authentication task(s) in the time allotted, then the requested data processing activity can be terminated (or optionally, other functions, e.g., other authentication challenges can be invoked). In a more specific embodiment, techniques based on inherence can be used, e.g., which rely on biometric features of the authorized user, and which therefore can only be passed using dynamic interaction with the authorized user (e.g., fingerprints, voice recognition, gesture performance, iris scan, and so forth). When invoked in connection with specific application-level or session-level queries, such techniques can be used to help thwart a majority of the attacks exemplified above.

In another embodiment, software and/or hardware invokes authentication tasks using Microsoft “Hello,” in a manner that is compliant with standards promulgated by the FIDO Alliance. Microsoft Hello can be configured to accept tests of inherence which satisfy the security thresholds of the adopting organization. These tests assure that only the authorized user is provided access, and only while in close geographic proximity to a login device (e.g., computer system of interest). In one embodiment, the described functionality is implemented in software (i.e., in the form of instructions stored on non-transitory machine readable media) utilizing existing platforms, infrastructure and/or components downloaded to and appropriately configured on an implementing system. These techniques can be adopted in/adapted to evolving systems such as FIDO-compliant and future systems that use tokens, cameras, biometrics or other 2FA functions, as they evolve in the future.

The described techniques can be integrated with user activity capture technology, proxies, API's and other techniques which observe user activity and allow the management of user initiated processes. For example, authentication processes can be dynamically invoked by software in response to detected user activity.
a. User activity on a device can be captured using keyloggers, click handlers, event hooking, and transparent screen overlays. These tools can be assembled into programs that can be installed in other applications, such as browser helper objects (BHO) which are installed in web browsers. Captured user input can be used to issue command and enable systems-management access.
b. A Cloud Access Security Broker (CASB) can be placed between the user's device and the remote systems in question for the purpose of intercepting user instructions to remote systems (for example websites) and controlling user access to the remote systems. CASB fall into two general categories, Proxies and API's:
   i. Proxy Implementation. With proxy implementations, a security service is interposed between the remote systems and the authorized user devices. Rather than accessing the remote service through the actual URL (e.g., “service.com”), the authorized devices are modified to access the service using a proxy URL (e.g., “proxy.service.com”). When the authorized device seeks to access the remote service, the security services of the CASB (such as user login authentication processes) are invoked. The proxy CASB only operates with regard to authorized devices which use the proxy to access the remote service.
   ii. API Implementation. With API implementations, the remote service provides an application programming interface (hence the moniker “API”) with which the CASB communicates. An API CASB is interposed between all user devices, both authorized and unauthorized devices. Because all users are subject to the requirements of the API CASB, the API CASB can be used to overlay identity and access (IdAM) requirements, in addition to and native IdAM requirements of the remote service, on all users seeking to use the remote service.

Processes which are invoked in response to user activity can be handled using an Interceptor. As used herein, the term “Interceptor” refers to a function in software (or implemented as a combination of software and circuitry) that identifies a native software procedure or method, for example, of an existing program (e.g., a command of a user entered with respect to a browser, such as to transfer funds in a banking client, or with respect to an email client to send an email, and so on), or of an operating system or a session exchange, and that conditionally or otherwise modifies it so as to reroute it, change its argument, or invoke one or more additional processing functions (e.g., to invoke authentication steps as taught herein). For example, a web browser might be tasked with accessing a URL, retrieving HTML code from a resource identified by the URL, storing that code on disk, and then executing the code to as to render a display; an Interceptor can be configured to intercept this call either specifically (e.g., access to a specific domain or URL) or because it matches a class of calls (access to protected memory) and to change its argument (e.g., rerouting to a proxy) or insert a new step or steps (e.g., authentication call) as a preliminary step. The Interceptor can be a native code function of a client or it can be something downloaded or executed (e.g., code downloaded from a web server), depending on embodiment. There are many examples of Interceptors and many functions that can be performed using them.

Whether the Interceptor is implemented using windows event hooking techniques or an API such as a browser extension or a computer utility plug-in, the role of the Interceptor is to monitor user actions for one or more protected functions (“PFs” or equivalently, “designated functions” or “DFs”), and to then automatically and transparently implement user additional authentication (e.g., based on presence technology) in accordance with the techniques discussed herein. In one embodiment, the Interceptor can be configured to wait for a specific user action, and then invoke reactions that are specific to that action (e.g., with potentially many Interceptors running in the background with different rules and associated reactions each adapted to different protected functions); in another embodiment, an Interceptor may be made generic to a range of user actions, or any requested access to a protected function that falls within a broad category). Combinations of these techniques may also be used. As this discussion makes clear, these techniques can be implemented in a number of different ways, typically by software, for example, in connection with access to protected resources (e.g., a computer's memory), functions performed within a particular software application, in connection with a predetermined operating system call, in connection with a particular interchange or command between machines (e.g., an on-line banking command to transfer funds), or in connection with access to a remote resource. In addition to being implemented specifically via a browser extension or plug-in (e.g., to an e-mail client), as alluded to above, the Interceptor function can also be implemented in many other ways, for example, as a native function in a given application program.

Prior to proceeding to detailed embodiments, it would be helpful to first introduce certain terms used herein.

Specifically contemplated implementations can include an apparatus comprising instructions stored on non-transitory machine-readable media. Such instructions (or “instructional logic”) can be written or designed in a manner that has certain structure (architectural features) such that, when the instructions are ultimately executed, they cause the one or more general purpose machines (e.g., a processor, computer or other machine) each to behave as a special purpose machine, having structure that necessarily performs described tasks upon input operands in dependence on the instructions, so as to take specific actions and/or otherwise produce specific outputs. “Non-transitory” machine-readable or processor-accessible “media” or “storage” as used herein means any tangible (i.e., physical) storage media irrespective of the technology used to store data on that media, e.g., including without limitation, random access memory, hard disk memory, optical memory, a floppy disk, a CD, a solid state drive (SSD), server storage, volatile memory, non-volatile memory, and other tangible mechanisms where instructions may subsequently be retrieved by a machine. The media or storage can be in standalone form (e.g., a program disk or solid state device) or embodied as part of a larger mechanism, for example, a laptop computer, portable device, server, network, printer, or other set of one or more devices. The instructions can be implemented in different formats, for example, as metadata that when called is effective to invoke a certain action, as Java code or scripting, as code written in a specific programming language (e.g., as C++ code), as a processor-specific instruction set, or in some other form; the instructions can also be executed by the same processor or different processors or processor cores, depending on embodiment. Throughout this disclosure, various processes will be described, any of which can generally be implemented as instructions stored on non-transitory machine-readable media. Also depending on implementation, the instructions can be executed by a single computer and, in other cases, can be stored and/or executed on a distributed basis, e.g., using one or more servers, web clients, or application-specific devices. Each function mentioned in reference to the various FIGS. herein can be implemented as part of a combined program or as a standalone module, either stored together on a single media expression (e.g., single floppy disk) or on multiple, separate storage devices; as used herein, the term “module” refers to a device comprising hardware logic (mechanical structures and/or elements) and/or instructional logic whose components are not shared with other modules or circuitry. For example, a “first module” to perform a first specific function and a “second module” to perform a second specific function, when used in the context of instructions (e.g., computer code) refer to mutually-exclusive code sets. When used in the context of mechanical or electromechanical structures (e.g., an “encryption module”) the term “module” refers to components which might also include circuitry, other forms of hardware (e.g., optical or electronic components), and/or software. In all cases, the term “module” is used to refer to a specific structure for performing a function or operation that would be understood by one of ordinary skill in the art to which the subject matter pertains as a conventional structure used in the specific art (e.g., a software module or hardware module), and not as a generic placeholder or “means” for “any structure whatsoever” (e.g., “a team of oxen”) for performing a recited function. “Electronic” when used to refer to a method of communication can also include audible, optical or other communication functions, e.g., electronic transmission can encompass optical transmission of information (e.g., via an imaged, 2D bar code), which is digitized by a camera or sensor array, converted to an electronic digital signal, and then exchanged electronically. “Mechanism” as referred to herein, does not represent a nonce or placeholder, but rather, refers to a structure comprising a set of mechanical elements, at least one of which is to be actuated to some type of motion or physical action, optionally under electronic or mechanical control; it may also include other structures, e.g., electrical, mechanical, fluidic, optical, etc., for supporting the associated actuation. Throughout this disclosure, various processes discussed herein can be optionally implemented as “logic” (e.g., as hardware or instructional logic configured to perform a particular function, or as a combination of these things, depending on embodiment or specific design). “Circuitry” as used herein refers to both general purpose circuitry (e.g., such as a generic processor) or application-specific circuitry, with individual circuits being shared between functions; for example, “circuitry to perform function A” can share elements with “circuitry to perform function B” and can potentially implemented using one common microprocessor. A “protected function” as used herein refers to any function which is designated as protected or for which an Interceptor is configured to apply filtering or processing; for example, access to protected memory or a protected resource can be one type of protected function. The terms “data storage area” and references to memory are used herein in the generic sense to refer to any non-transitory retention mechanism that allows data to be stored in a structured and accessible fashion using such applications or constructs as databases, tables, linked lists, arrays, and so on. Various other terms will be defined elsewhere herein, or will be used in a manner apparent from context.

### B. Exemplary Environment.

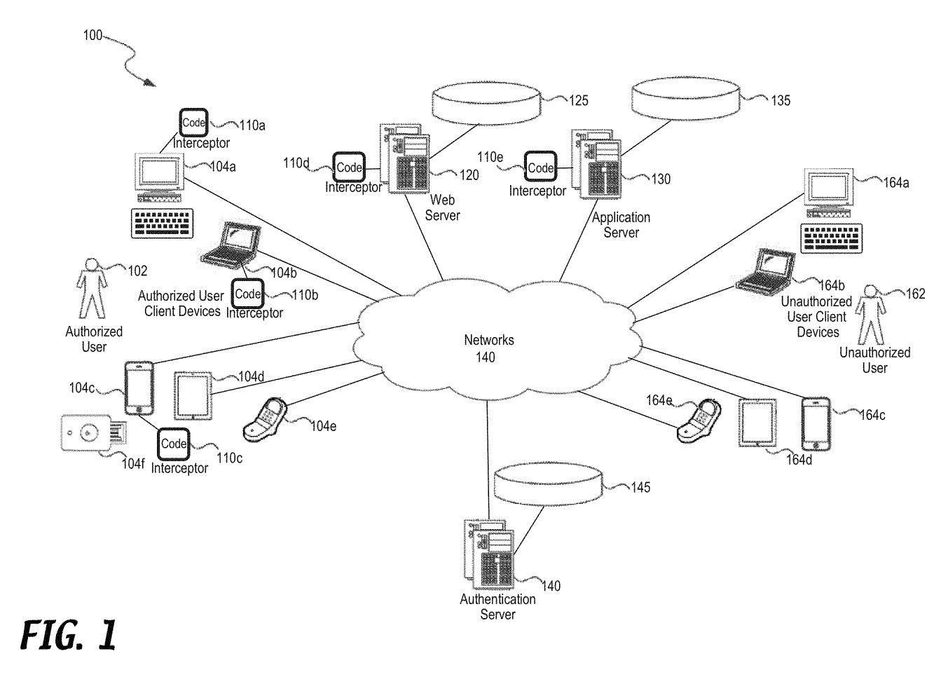

A system rooted in dynamically-invoked presence detection (PD) can be implemented in a suitable computing environment 100, such as the one shown in FIG. 1. Client devices, such as desktop computer 104a, laptop computer 104b, mobile device 104c, tablet 104d, feature phone 104e, and the like, are used by authorized users (e.g., 102) to access websites that are hosted by server computers, such as web server 120 and application servers 130 or applications running on client device (such as an industrial control program running on the client device). An authentication server may connect to and communicate with other servers or client devices across networks 150. Networks 150 may include wired and wireless, private networks and public networks (e.g., the Internet). The client devices 104a-104e use network interfaces (local or wide-area) to connect and/or communicate with networks 150, either directly, or via wireless routers or cell towers. The network interfaces may employ connection protocols such as direct connect, Ethernet, wireless connection such as IEEE 802.11a-n, and the like to connect to networks 150. Some client devices such as devices 104d-104f may be equipped with transceiver circuitry to handle radio communications to wirelessly communicate with nearby cell towers or base stations using wireless mobile telephone standards such as Global System for Mobile Communications (GSM), CDMA (Code Division Multiple Access), General Packet Radio Service (GPRS), and/or the like. Some of these client devices may be designated as “login clients” while others as “verification clients.” A login client as used herein refers generally to a client device used for logging in or signing in to a website, application server or application running on the login device itself (such as a program running on the login computer). A verification client as used herein refers generally to a client device that is charged with performing a MFA (e.g., 2FA). A verification client in one embodiment can be a mobile device, of a type that will be in the user's possession at the time of login (e.g., a smart phone). A verification client can also be a dedicated verification device, such as Yubikey 104f. Some client devices, such as device 104b, can be equipped with biometric scanning devices to enable biometric OTP functions as described in Nguyen and Nguyen, “An Approach to Protect Private Key using Fingerprint Biometric Encryption Key in BioPKI based Security System,” 2008 10th Intl. Conf. on Control, Automation, Robotics and Vision Hanoi, Vietnam, pp. 1595-1599, 17-20 Dec. 2008; in addition to fingerprint scanners, the depicted client devices 104a-104f as depicted should be understood to optionally include built-in biometric devices of other types, for example, cameras, 3D recognition technology, voice recognition equipment and other biometric measurement devices.

The client devices can be used as verification clients. For example, SMS enabled devices 104c-104e can receive one-time passwords (OTPs) which are then entered by the user into the client login device 104a for completion of a 2FA login. Services transmit OTP challenge information from the authentication server 140 of the network 150 to the login client 104a, which can be visually displayed on the display of the login device 104a for capture by the camera in the verification client 104e; this captured information is then transmitted over the network 150 to the authorization server 140 for the authorization server to validate the OTP transaction. For example, using an application marketed by CLEF, Inc. of Oakland, Calif., the user is required to enter a PIN (what you know) on the verification device in order to access to the camera based OTP authentication. Services such as Microsoft Hello use a camera login process employing the camera of the login device 104b to capture a real time video of the user 102 seeking to login, which real time video is compared by the authentication server to reference video for user authorization; in the Microsoft Hello process the same client device 104b is acting as the login client and the verification client. Any of the biometric measurement technologies referenced herein (or otherwise known to those having ordinary skill in the art) can be used and/or integrated with verification clients as referenced herein (e.g., including without limitation, fingerprint scanners, voice recognition devices and so forth).

The token 104f is a verification client that in one embodiment may be engaged by: i) by inserting it into a connector, such as a USB connector in the login client—the verification client then initiates a 2FA transaction by communicating with the authentication server 140 over the network 150, e.g., when the user pushes the button on the device, or ii) by virtue of its NFC functions, by tapping the token 104f against an NFC enabled login client, with the token 104f then initiating a 2FA transaction by communicating with the authentication server 140 over the networks 150. Tokens can take many form factors. Additionally, tokens can implement numerous MFA systems, including without limitation 2FA systems. The OTP standard promulgated by the FIDO Alliance attempts to mitigate man-in-the-middle attacks on OTP authentication systems. FIDO-complaint tokens can also take many form factors. For example, a set of headphones can be equipped to provide FIDO-complaint authentication, offering the user the convenience of using a device that: i) Provides the user with features of value to the user; ii) Relieves the user of the need to manage a security specific device (reducing the nuisance factor of a dedicated token—“I left my token at home, now I can't do any work”); and iii) Provides the security features of FIDO-promulgated standard. In one embodiment, the user login client 104b can be implemented as a FIDO-compliant implantation of Microsoft Hello using the camera on user device 104b (or other biometric capture mechanisms such as those referred to earlier), in order to serve as the verification client.

Authentication information service 140 is a server or servers that may be coupled to one or more database tables such as database table 145. In one embodiment, the authentication information service 140 may be operated by a third party to provide authentication services and/or authentication information to requesting clients such as client devices 104a-104f, web server 120 and/or an application server 130. In another embodiment, the authentication information service 140 may be provided by a server or servers operated by or under the control of a web server 120 or application server 130. The operating entity can then directly access verification client authentication data determined by the authentication information service 140. In yet another embodiment, the authentication information service 140 may be a part of web server 120 or application server 130, and not a separate server. In other words, the web server 120 or application server 130 can be configured to perform all of the functions of verification (and of the authentication information service 140). For applications that are operating on the login client 104a, login client 104a can be configured to perform all of the functions of the verification information server 140 and/or application server 130. The client devices 104a-104e can also be application servers, providing applications on the device itself. In one embodiment, the functions of the authentication information service 140 are segregated from the client devices 104a-104e such that the verification information server can be maintained (which maintenance includes enrolling and withdrawing authorized user 102, and enrolling and withdrawing verification clients 104a-104e) irrespective of the accessibility of verification clients 104a-104e; in other words, the verification information server can control verification even in cases where verification clients 104a-104e are lost or stolen or where the operator of the verification information server 140 decides to revoke the privileges of user 102 without requiring the cooperation of user 102.

Note that these examples are non-limiting. For example, in other embodiments, as implied, the authentication functions including the authentication information service 140 can be stored locally on client device (or login device); for applications where it is desired to protect a remote resource, such a configuration may not prevent third party attacks which do not use the client device. However, these techniques can still be used. In embodiments where the protected function involves a function of the client device (for example, control over access to protected memory), these techniques can be particularly effective. For several embodiments discussed below, it will be assumed that the protected function in question involves distributed or remote access (that is, over some type of local or wide area network), but it should be understood that the modules, features and functions described herein are not so limited, and may be used for security within a single device only.

Continuing with the earlier example, the web server 120 depicted in FIG. 1 is a server that hosts one or more websites and stores data. Web servers deliver web pages to requesting clients. The depicted web server 120 can be coupled to one or more database tables such as database table 125. The application server 130 is a server that hosts one or more applications and stores data. Application servers deliver applications to requesting clients. The depicted application server 130 can be coupled to one or more database tables such as database table 135. The authentication information service 140 can be provided by a dedicated server handling authentication of users and/or client devices, and can be coupled to one or more database tables, such as database table 145. When users attempt to access designated functions (DFs) either for the first time or on subsequent visits, requests are sent to the authentication server 140 to authenticate the user.

Database tables 125, 135 and 145 store data utilized by the authentication system, and, in some implementations, these tables also store software used to perform various functions of the system. Data stored in memory of client devices 104a-104f can include data utilized by the PD system and, in some implementations, can similarly also source software used to perform various functions of the system. The term “server” as used herein refers generally to a computer, device, program or combination thereof that processes and responds to requests from remote clients across a network. The term “client” as used herein refers generally to a computer, device, program or combination thereof that is capable of processing and making requests, obtaining and processing responses (optionally from servers via a network).

### C. Suitable Systems.

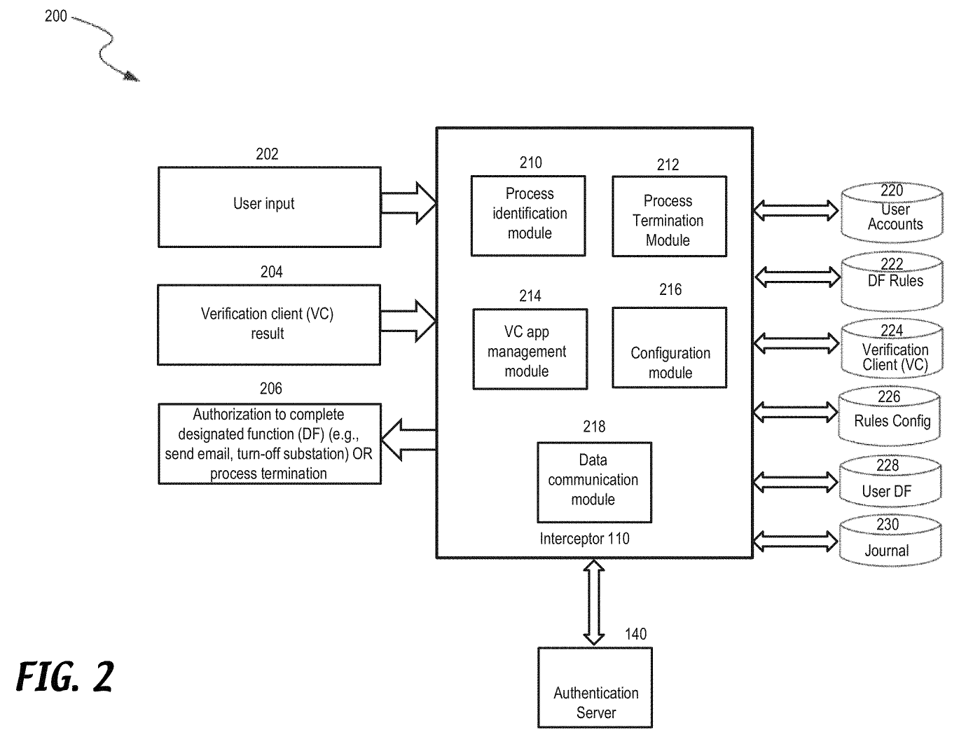

FIG. 2 is a block diagram of a system that provides for multi-factor authentication, including dynamic authentication techniques as referenced herein. The system 200 receives as input user-provided requests to perform data processing functions and authentication responses relating to one or more user-associated client devices; the system 200 performs authentication with direct user involvement, and provides as an output authorization to access a requested resource (if appropriate). In the process of performing the authentication tasks, the system 200 advantageously applies one or more authentication rules to the user verification data, and in some implementations, can also use this data to dynamically adjust thresholds for successful authentication.

Various inputs can be provided to an Interceptor 110 as part of the authentication process. For example, a user response 204 can be provided to the authentication service 140 to allow the server to perform authentication of the user based on one or more factors. The 2FA authentication factor can be selected from the three aforementioned general authentication factor categories, which include something the user knows, something the user has and something the user is. This selection can optionally be preconfigured by the designer of the authentication service, or it can be dynamically and/or deterministically performed. The user verification data 204 can be automatically or interactively acquired and can include whichever information is appropriate to the authentication process; by way of non-limiting example, this data can include one or more of a username, a password, a security code, a token, a biometric characteristic such as a fingerprint, gesture, voice command, and the like, or another suitable response. As noted earlier, advantageously, at least one factor (and associated response) can be based on inherency, i.e., such that only the authorized user can provide the appropriate response (because the authorized user is himself or herself the source of the response data). Note that the verification data 204 typically involves two or more factors, with some of these factors being previously-provided by the user in question. For example, in one implementation, dynamically-acquired information (e.g., an iris scan) can be linked to the login credentials supplied at original user login and used to form MFA data; many such examples are possible.

Output 206 can be an authorization granting the requesting user access to the requested resource, provided that the user has passed the authentication check(s) performed by the server 140, as required by the Interceptor 110.

The Interceptor in this embodiment is seen to include a process identification module 210, a process termination module 212, a verification client application management module 214, a configuration module 216 and a data communication module 218. One or more of these modules connects to one or more datasets or database tables 220-230 to execute queries, such as those written in Python, PhP, SQL, and the like, to retrieve and/or store data. Depending on the implementation, the modules 210-218 may be implemented in software (e.g., instructions stored on non-transitory machine-readable media), hardware, or a combination thereof. The operation of each of these modules will be described in additional detail herein.

In the depicted embodiment, these modules access one or more tables to perform user authentication. As seen, these database tables can include a user accounts table 220, a designated functions rules table 222, a verification client table 224, a rules configuration table 226, a user-data function (DF) table 228, and/or a journal table 230. The user accounts table 220 typically includes data fields such as user ID or username, password, biometric signature, name, address, email, mobile phone number or mobile identification number (MIN), unique device identifier, permissions, permitted entities, and the like. The designated function rules table 222 can include fields such as DF ID, protected process unique identifiers, program instructions that identify one or more protected processes, and the like. The verification client table 224 can include data fields such as an authentication-process ID, one or more specific authentication methods, rules and conditions that can be evaluated and used to dynamically configure authentication methods, and so on. The rules configuration table 226 can include data fields such as rule ID, DF ID, authentication-process ID (2FA ID), thresholds for attempts, process termination instructions as fallback for cases where the authentication process does not terminate, and similar rules. The user-DF table 228 typically contains the user IDs of authorized users and a corresponding DF ID, thereby associating authorized users with designated functions. The journal table 230 can include data fields such as user ID, time, rule ID, DF ID, verification result, and the like.

Authentication is performed by a process (e.g., a 2FA process) specified in the rules configuration table 226, subject to the rules in rules configuration table 226. For example, the threshold attempts field can be used to impose a maximum number of attempts irrespective of the limits of the designated authentication process so that after the number of attempts in the rules configuration table is exceeded, the authentication process will terminate. Alternatively, the rules can specify other fields and requirements, for example, further (e.g., an increase number of) specific authentication tests and/or other conditions in the event of an authentication failure (or other dynamically-evaluated conditions). By way of further example, the process termination instructions can provide for rules in addition to the requirements of the specified authentication method as a further safeguard.

The process identification module 210 determines if a designated function (DF) has been requested by way of user inputs using the login client 305.

The process termination module 212 terminates the authentication process using rules in the rules configuration table to backstop the termination processes native to the specified MFA method.

The verification client application management module 214 controls the authentication process(es).

The configuration module 216 includes user interfaces for creating, editing, reading and outputting data from tables 220-228.

The data communication module 218 includes computer executable instructions for obtaining, processing and managing data. For example, the data communication module will, depending on embodiment, communicate with a verification client and/or an authentication server 140. This module will also typically process and store authentication data in one or more database tables such as journal table 228, and process an authorization output 206 from the authentication server.

In some implementations, one or more modules 210-218 can instead be consolidated into a single module or their functions can be arranged in different modular groupings.

### D. Processing Examples.

One embodiment of the system utilizes 2FA services, either directly or indirectly, to verify users attempting to perform a DF. Logic and data flow diagrams described below illustrate example processing performed by the system to authenticate users in a manner that ideally imposes minimal burden on a user.

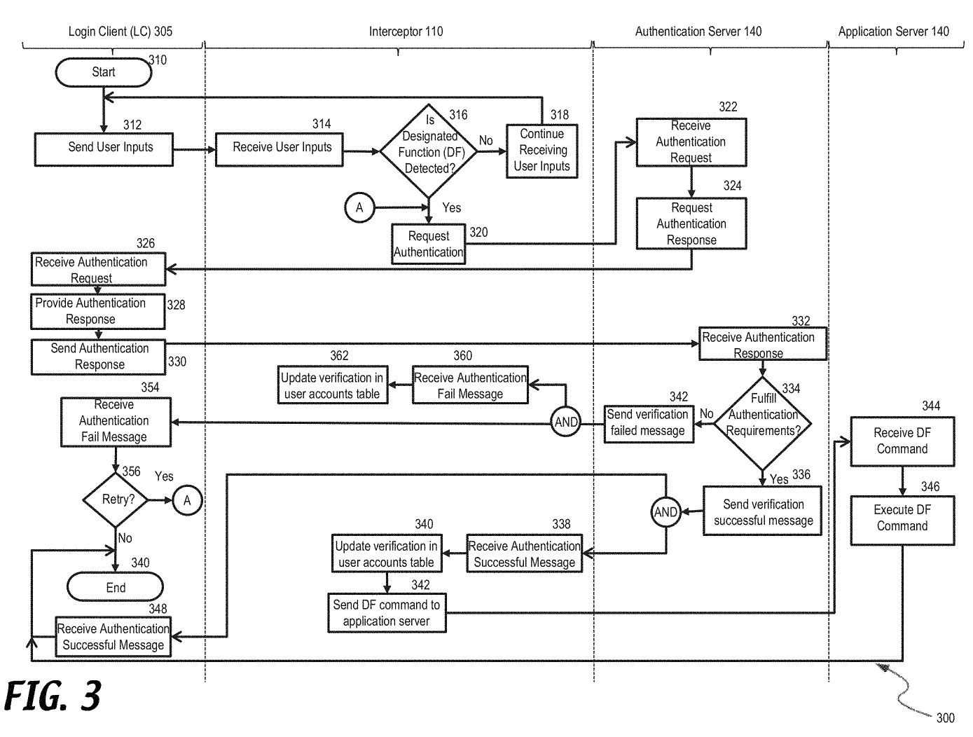

The embodiment depicted in FIG. 3 leverages a variety of authentication alternatives that exist and/or will be developed in the future, allowing the selection of one or more methods attuned to balance security and usability. A user typically uses a login client 305 to request a data processing service from a website or application. The requested data processing service can be hosted by a server (e.g., web server 120 or application server 130), while an authentication server 140 can be charged with verifying the authorization of the user. Depending on the implementation, the authentication server can be an entity separate from the server hosting the requested data processing service, or it may be the one and the same server. Furthermore, in some implementations, certain aspects of the user verification may be performed by the web/application server, while other aspects may be performed by the authentication server.

Referring to FIG. 3, at block 312, the login client provides user data processing requests.

At block 326 the Interceptor 110 receives the login client data processing requests from the user via the login client. The Interceptor parses the data processing requests data to extract data processing requests corresponding to one or more DFs stored in DF tables such as the designated function table 222. At decision block 316, the Interceptor 110 determines if the user action or input 314 corresponds to a DF in the DF tables. If a DF table entry does not match the data corresponding to input 314, then the user is permitted to continue data processing and continues to block 312. Conversely, if a DF is found in the received data, then the Interceptor 110 at block 320 invokes the one or more of the pertinent authentication tests (e.g., 2FA) determined from the rules configuration table 226.

At block 322 the authentication server 140 receives the request for authentication processes from the Interceptor 110. At block 324 the authentication server issues an authentication request to the login client 305, i.e., for a specific MFA process such as a specific 2FA.

At block 326 the login client 305 receives the authentication request. At block 328 the user attempts to perform the requested authentication task(s) and that attempt is captured by the login client 305. At block 330 the login client sends the response collected in block 328 to the authentication server 140.

At block 332 the authentication server 140 receives the authentication response from the login client 305. At block 334 the authentication server 140 determines if the authentication response satisfied the requirements of the designated authentication process (e.g., each factor of a MFA process). If the response satisfied the requirements, then at block 336 a verification successful message is sent. Conversely, if the requirements are not satisfied, a verification failure message is sent in block 352.

In the case of successful verification message block 336, the successful verification message is sent to the Interceptor 110 and received at block 338, AND the successful verification message is sent to the login client 305 and is received by the login client at block 348. Following receipt of the successful verification message at block 338, in block 340, the Interceptor 110 updates the verification data in the user account. Then, in block 342, the Interceptor sends the DF command to the application server 140. In block 344, the application server 140 receives the DF command. In block 346, the application server 14 executes the DF command. After execution of the DF command at block 350, the process terminates.

After a verification failure message is sent in block 352, the verification failure message is received by the Interceptor 110 in block 360 and by the login client 305 in block 354. After block 360, the Interceptor 110 updates the verification data in the user accounts table in block 362. After block 354, the login client offers the user the alternative of retrying the authentication task(s) in decision block 356. If the user selects “retry” in decision block 356, then per block 320, the Interceptor 110 requests authentication. Conversely, if the user does not elect to retry verification at decision block 356, then the process is terminated at block 350.

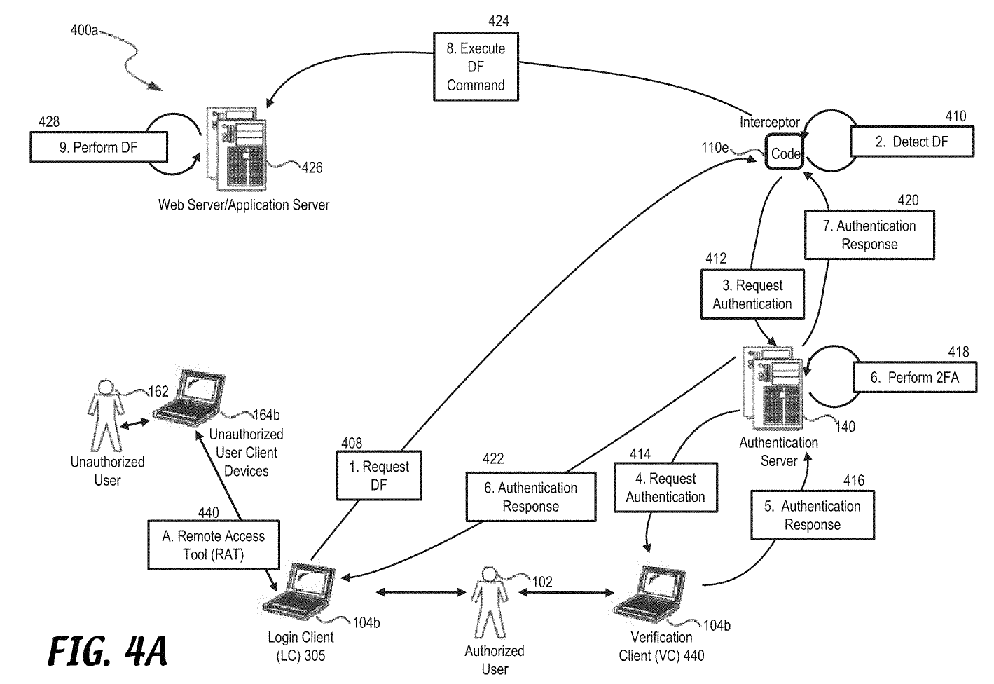

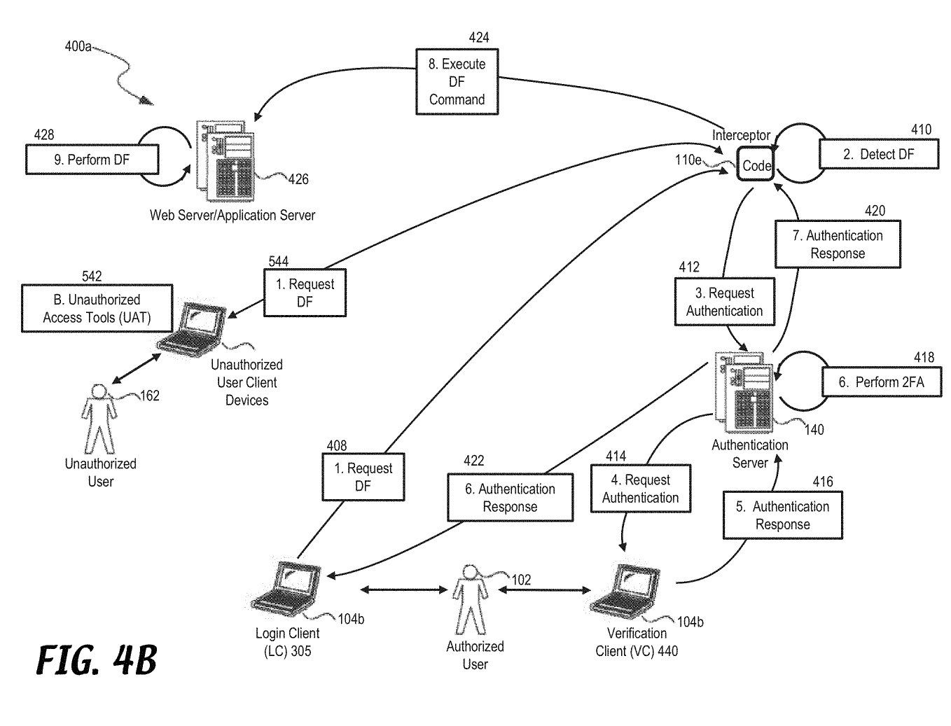

FIG. 4A and FIG. 4B are data flow diagrams illustrating user authentication and how authorized users and unauthorized users receive different treatment. FIG. 4A and FIG. 4B illustrate an embodiment in which FIDO-complaint Microsoft Hello is used; in this case, a single user device serves both as the login client 305 and the verification client 440.

Referring to FIG. 4A, the authorized user 102 submits a data processing request 408. At block 410, the Interceptor 110e detects a request to perform a designated function (DF). The Interceptor packages and transmits the request for 2FA in a message 412 to the authentication server 140. The authentication server receives the resource request message, and responds with a request 414 to the user to provide an authentication response. In the depicted embodiment, the verification client 104b (which device is also the login client) provides a screen display prompting the user to perform a gesture. The user response to request 414 is packaged by the verification client and sent to authentication server 140 in block 416. At block 418 the authentication server 418 performs the authentication process. At block 422, the user is advised of the results of the authentication process. The authentication results are also sent to the Interceptor 110e in block 420. If the authentication response is that the user is successfully performed the authentication process, then the Interceptor 110e packages and send the command to the webserver/application server block 424 to execute the DF command. In response to the execute command of block 424, at block 428, the webserver/application server 426 performs the DF.

FIG. 4A depicts a situation where an unauthorized user 162 is attempting to access the login client 104b by means of a RAT, in block 440. The RAT allows the unauthorized user 162 to operate login client 104b from an unauthorized user client device 164b. This is the model similar to that observed in the Ukraine power grid compromise and the drone community compromise, described by Alienvault Labs and referenced above. If the unauthorized user 162 issues a DF using RAT 440, the DF request 408 will initiate the process described in the previous paragraph. However, because the unauthorized user 162 will be unable to complete the authentication (e.g., 2FA) request from unauthorized user client device 162b, the authentication will fail and DF will not be executed. If the DF had been, as was the case in the Ukraine power grid compromise, a request for a substation shut-down or password change, then that compromise would be expected to fail given the system architecture introduced herein (i.e., the requests would have required biometric (or other additional) confirmation from the correct authorized user that originally logged into the client. Even if the authorized user 102 is logged into the system using a PIV or CAC and is using sessions created by the authorized user 102, when the unauthorized user 162 seeks to invoke a DF, the unauthorized user 162 will face a requirement for a new authentication factor which must be obtained from correct authorized user 102, dynamically, at the moment that unauthorized user 162 requests a DF. As referenced earlier, in embodiments where the new authentication factor requests an inherent token, specifically, e.g., biometric feature of the authorized user, the presence and direct involvement of the authorized user is required.

It should be observed that these techniques call for the authorized user 102 to act as a bridge between the login client 305 and the verification client 440. This bridging function must be completed consistent with the parameters established in the Interceptor 110e in order for the DF to be completed. By selecting authentication tasks for dynamic invocation that are readily accessible to the authorized user 102, yet hard for an unauthorized user 162 to exploit, the unauthorized user 162 can be denied control of the DF. Thus, a ‘what you know” 2FA factor (e.g., John Podesta's username and password) while usable for some applications might provide less security than an inherency factor, because an unauthorized user (e.g., 162) can potentially possess (e.g., steal) and use that knowledge to accomplish the bridging function without being easily detected. Contrast a “what you know” factor to a “what you have” factor that is verified using a FIDO-compliant OTA token system such as Yubikey; the Yubikey can only be possessed by one person at a time and its absence is easily detected and reported by the authorized user 102. Although one cannot maintain exclusive control over images of one's self, the Microsoft Hello FIDO implementation of “what you are” is easy for the authorized user 102 to successfully complete but is, for practical purposes, extremely difficult if not impossible for the unauthorized user 162 to successfully complete. This bridging function when properly configured is highly correlated with the authorized user 102 being simultaneously physically proximate to both the login client 305 and the verification client 440 to perform the activities required to complete the DF.

FIG. 4B differs from FIG. 4A in the compromise methodology being employed by the unauthorized user 162. In FIG. 4B, instead of using a RAT, the unauthorized user 162 is assumed to be using stolen credentials.

This is similar to the case encountered in the John Podesta compromise in which Podesta was tricked into revealing his Gmail login credentials (i.e., username and password). With Podesta's credentials in hand, an attacker was able to login to Podesta's Gmail account and send email from Podesta's Gmail account, thus enabling a multi-stage spearphishing attack. Thus, with Podesta, the unauthorized user was able to login to a webserver/application server using an unauthorized access tool (e.g., UAT 542), using Podesta's credentials.

In the case, however, of a UAT attack represented by FIG. 4B, when the unauthorized user 162 uses UAT to access the webserver/application server 426 directly without routing the session through the login client 305, the request DF of block 544 will be directed to the Interceptor 110e. As was the true for the scenario of FIG. 4A, the Interceptor 110 will initiate an authentication process which unauthorized user 162 will be unable to successfully complete because, again, the unauthorized user will be dynamically asked to provide new authentication information that ideally only the true authorized user possesses (e.g., biometric features corresponding to the authorized user that originally logged onto the client device or initiated the session in question).

In the event an unauthorized user (e.g., 162) is able to obtain the data required to complete a given authentication task (for example, the OPM breach which resulted in the compromise of the fingerprints of 4 million people), the Interceptor can be reconfigured to replace one authentication test (e.g., fingerprint matching) with a second authentication test (e.g., a test other than fingerprint matching). Also, as noted earlier, in some embodiments, a dynamically-invoked authentication task, triggered by a user action, can involve any number of deterministically selected tasks chosen from a group of tasks, or can be randomly selected (e.g., and governed by time limits and other pertinent rules), or be adapted based on context, such as elapsed time or recent authentication failures, making it difficult for an attacker to predict which method will be used at any point in time.

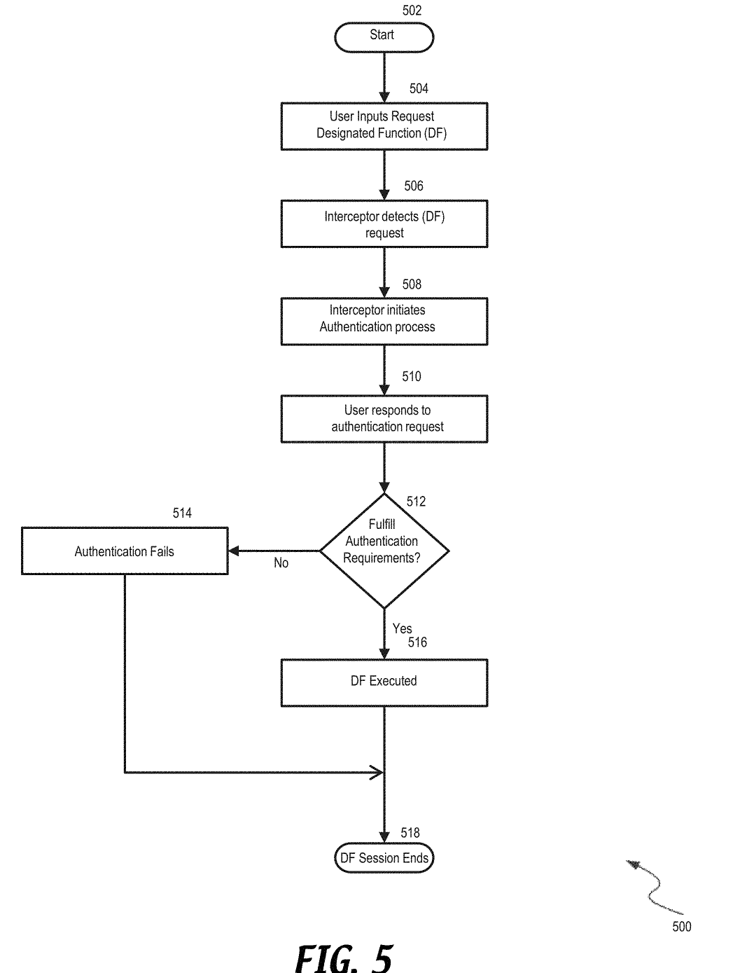

FIG. 5 is a logic flow diagram exemplifying authentication flow. As shown, at block 504, a user requests execution of a DF. In response to this request at block 506, the Interceptor detects the request to execute a DF. At block 508, the Interceptor initiates the authentication process. At block 510, a user response to a factor of authentication may be obtained. For example, when a gesture is requested (e.g., something the user “is,” that is, inherence), the user may provide a gesture. In another example, if the factor of authentication is related to something the user has, the user may respond with a card swipe, a card identifier, a one-time password or token, and the like. At decision block 512, the authentication results are determined. If authentication response satisfies the authentication requirements, then the DF is executed. Conversely, if the authentication response at decision block 712 does not satisfy the authentication requirements, the user may be allowed a limited number of attempts to provide the correct response at block 514. If all attempts to provide a correct response fail, the process exits, with the user being denied execution of the DF.

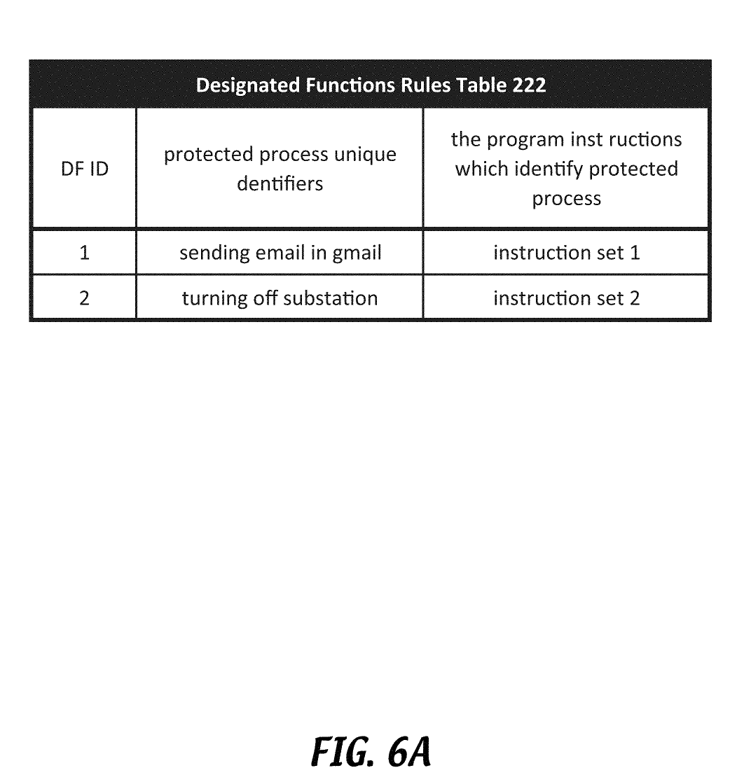

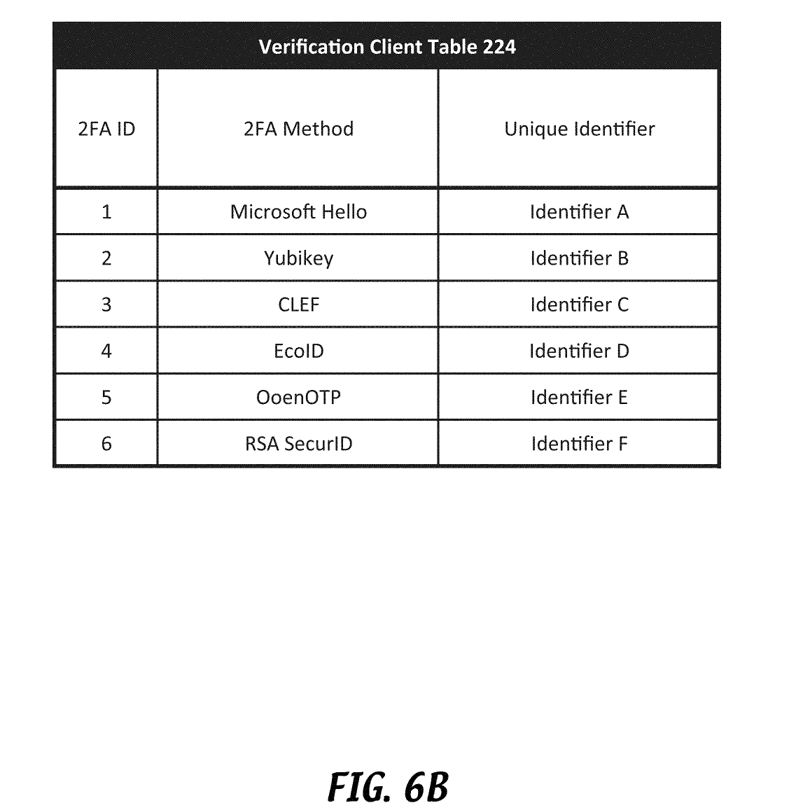

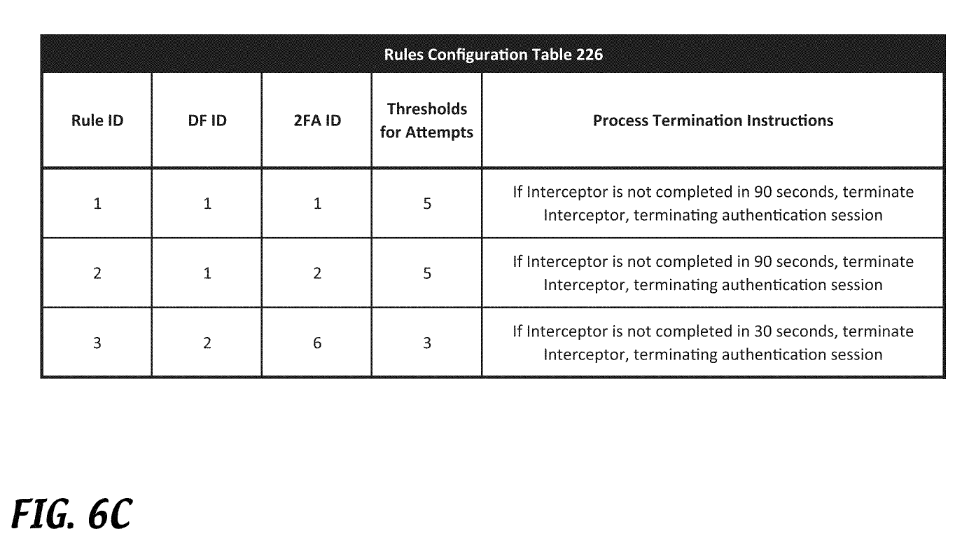

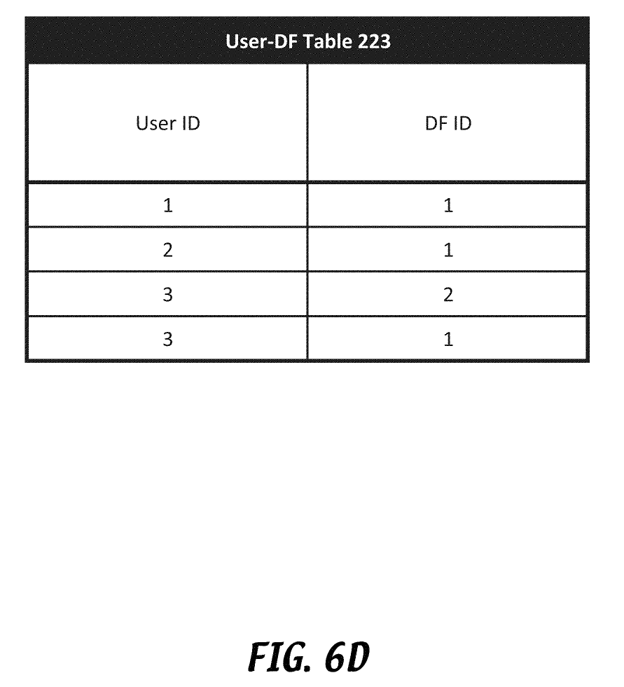

FIGS. 6A, 6B and 6C illustrate examples of authentication rules in an embodiment. FIG. 6A illustrates an exemplary designated functions rules table 222. FIG. 6B illustrates an exemplary verification client table 224. FIG. 6C illustrates a possible rules configuration table 226. FIG. 6D illustrates a possible association of User ID to DF ID, thereby defining the set of authorized users for each DF. The conditions, outcomes and rules discussed herein are exemplary, and are not exhaustive. Various other conditions and combinations of such conditions are within the scope of this application.

Various alternatives to the foregoing techniques will readily occur to those having skill in the art. To pick just a few examples, while embodiments have been described above which use an Interceptor to add at least one dynamically-invoked authentication step, for example, based on inherence, the techniques presented by this disclosure are not so limited. For example, it is possible to insert authentication steps which are predicated on the use of knowledge or possession based techniques as well, or a combination of techniques. Furthermore, as will no doubt occur to those having ordinary skill in the art, invoked authentication can be combined with many other security features to enhance robustness of applied authentication. For example, the failure of a purported authorized user to complete authentication a first time can be used to invoke other functions or processing steps based on rules; in one example, authentication failures can be logged, or used to trigger other authentication steps, or to reroute communications for additional screening. Furthermore, techniques presented by this disclosure can be implemented in the form of web-based code, as part of an operating system or native software application, in a manner bundled with hardware (e.g., a firmware supported feature of a secure client login device, or a feature invoked by an application server or web server), or in some other manner; in one embodiment, for example, the techniques referenced herein can be implemented in firmware on an integrated circuit (IC), or otherwise bundled with protected circuitry or on a protected device (e.g., integrated with hardware which gates access to a secure data storage drive or array). Many other variations also exist and will occur to those of ordinary skill in the art.

Accordingly, the foregoing discussion is intended to be illustrative only; other designs, uses, alternatives, modifications and improvements will also occur to those having skill in the art which are nonetheless within the spirit and scope of the present disclosure, which is limited and defined only by the following claims and equivalents thereto. For example, while processes or blocks are presented in a given order, alternative implementations may perform routines having steps, or employ systems having blocks, in a different order, and some processes or blocks may be deleted, moved, added, subdivided, combined, and/or modified to provide alternative combinations or subcombinations. Each of these processes or blocks may be implemented in a variety of different ways. Also, while processes or blocks are at times shown as being performed in series, these processes or blocks may instead be performed or implemented in parallel, or may be performed at different times. In general, the terms used in the following claims should not be construed to limit the invention to the specific examples disclosed in the specification. Accordingly, the actual scope of the invention encompasses not only the disclosed examples, but also all equivalent ways of practicing or implementing the invention under the claims.

We claim:

1. A computer-implemented method, comprising:
providing a software interceptor to intercept a request for a system resource, wherein the software interceptor is to determine whether the request matches at least one of a predetermined request type or a request for a predetermined resource;
dynamically-invoking at least one authorized-user authentication test responsive to the request, in the event that the software interceptor determines that the request matches the at least one of the predetermined request type or the request for the predetermined resource;
processing the request for the system resource in the event that the at least one authorized user authentication test is successfully passed; and
denying the request for the system resource in the event that the at least one authorized-user authentication test is not successfully passed.

2. The computer-implemented method of claim 1, wherein the at least one authorized-user authentication test comprises at least one biometric challenge, wherein the computer-implemented method is to be executed using a user device, and wherein the computer-implemented method further comprises:
accessing a login credential of a user that originally logged into the user device;
causing a biometric capture device of the user device to dynamically capture biometric information of the user that originally logged into the user device;
determining whether the dynamically-captured biometric information satisfies the at least one biometric challenge; and
determining that at least one test of the at least one authorized user authentication test is passed in the event that the dynamically-captured biometric information satisfies the at least one biometric challenge.

3. The computer-implemented method of claim 2, wherein the login credential is stored in a detachable hardware device, wherein the computer-implemented method is embodied in a system that requires continued electronic connection between the detachable hardware device and a client computer, and wherein:
the accessing comprises accessing the login credential from the hardware device in a manner responsive to the request;
the computer-implemented further comprises transmitting information depending on the logic credential and the dynamically-captured biometric information via a network to a remote destination, and receiving a validation responses from the remote destination; and
the processing and the denying are performed in dependence on the validation response received from the remote destination.

4. The computer-implemented method of claim 3, wherein the detachable hardware device comprises a smartcard.

5. The computer-implemented method of claim 2, wherein the biometric capture device comprises at least one of a fingerprint scanner, a camera or a microphone.

6. The computer-implemented method of claim 2, wherein the determining whether the dynamically-captured biometric information satisfies the at least one biometric challenge comprises performing at least one of fingerprint matching, facial recognition, voice recognition, gesture recognition or iris recognition.

7. The computer-implemented method of claim 1, wherein the request comprises a request for a remote resource via a network, and wherein the dynamically-invoking comprises accessing via the network at least one file to identify the at least one authorized-user authentication test, responsively collecting user authentication response data at a client device, determining whether the collected user authentication response data matches verification information stored in the network, and authenticating at least one factor of the at least one authorized-user authentication test in the event that the authentication response data matches the verification information stored in the network.

8. The computer-implemented method of claim 7, wherein the computer-implemented method further comprises downloading the verification information stored in the network to the client device, and performing the determination as to whether the user authentication response data matches the verification information on the client device.

9. The computer-implemented method of claim 7, wherein the computer-implemented method further comprises uploading the authentication response data via the network to a server, and performing the determination as to whether the user authentication response data matches the verification information on the client device.

10. The computer-implemented method of claim 1, wherein the providing comprises providing the Interceptor as part of at least one of a cloud access security broker, a proxy, a browser extension, a computer-utility plug in, or an application programming interface.

11. An apparatus comprising instructions stored on non-transitory machine-readable media, the instructions when executed to cause at least one processor to:
provide a software interceptor to intercept a request for a system resource, wherein the software interceptor is to determine whether the request matches at least one of a predetermined request type or a request for a predetermined resource;
dynamically-invoke at least one authorized-user authentication test responsive to the request, in the event that the software interceptor determines that the request matches the at least one of the predetermined request type or the request for the predetermined resource;
process the request for the system resource in the event that the at least one authorized user authentication test is successfully passed; and
deny the request for the system resource in the event that the at least one authorized-user authentication test is not successfully passed.

12. The apparatus of claim 11, wherein the at least one authorized-user authentication test comprises at least one biometric challenge, wherein the instructions are to be at least partially executed using a user device, and wherein the apparatus further comprises instructions that when executed are to cause the at least one processor to:
access a login credential of a user that originally logged into the user device;
cause a biometric capture device of the user device to dynamically capture biometric information of the user that originally logged into the user device;
determine whether the dynamically-captured biometric information satisfies the at least one biometric challenge; and
determine that at least one test of the at least one authorized user authentication test is passed in the event that the dynamically-captured biometric information satisfies the at least one biometric challenge.

13. The apparatus of claim 12, wherein the login credential is stored in a detachable hardware device, wherein the apparatus is to be used by a system that requires continued electronic connection between the detachable hardware device and a client computer, and wherein:
the instructions are to cause the at least one processor to access the login credential from the hardware device in a manner responsive to the request;
the instructions when executed are to cause the at least one processor to transmit information depending on the logic credential and the dynamically-captured biometric information via a network to a remote destination, and receive a validation responses from the remote destination; and
the at least one processor is to process the request in dependence on the validation response received from the remote destination and is to deny the request in dependence on the validation response received from the remote destination.

14. The apparatus of claim 13, wherein the detachable hardware device comprises a smartcard.

15. The apparatus of claim 12, wherein the biometric capture device comprises at least one of a fingerprint scanner, a camera or a microphone.

16. The apparatus of claim 12, wherein the instructions when executed are to cause the at least one processor to determine whether the dynamically-captured biometric information satisfies the at least one biometric challenge by causing the at least one processor to perform at least one of fingerprint matching, facial recognition, voice recognition, gesture recognition or iris recognition.

17. The apparatus of claim 11, wherein the request comprises a request for a remote resource via a network, and wherein the instructions when executed are to cause the at least one processor to access via the network at least one file to identify the at least one authorized-user authentication test, responsively collect user authentication response data at a client device, determine whether the collected user authentication response data matches verification information stored in the network, and authenticate at least one factor of the at least one authorized-user authentication test in the event that the authentication response data matches the verification information stored in the network.

18. The apparatus of claim 17, wherein the instructions when executed are to cause the at least one processor to download the verification information stored in the network to the client device, and perform the determination as to whether the user authentication response data matches the verification information on the client device.

19. The apparatus method of claim 17, the instructions when executed are to cause the at least one processor to upload the authentication response data via the network to a server, and performing the determination as to whether the user authentication response data matches the verification information at the server.

20. The apparatus of claim 11, wherein the instructions when executed are to cause the at least one processor to provide the Interceptor as part of at least one of a cloud access security broker, a proxy, a browser extension, a computer-utility plug in, or an application programming interface.

21. The apparatus of claim 11, embodied as a server.

22. The apparatus of claim 11, embodied as a client device.

23. An apparatus, comprising:
means for providing a software interceptor to intercept a request for a system resource, wherein the software interceptor is to determine whether the request matches at least one of a predetermined request type or a request for a predetermined resource;
means for dynamically-invoking at least one authorized-user authentication test responsive to the request, in the event that the software interceptor determines that the request matches the at least one of the predetermined request type or the request for the predetermined resource;
means for processing the request for the system resource in the event that the at least one authorized user authentication test is successfully passed; and
means for denying the request for the system resource in the event that the at least one authorized-user authentication test is not successfully passed.
